(19) United States
(12) Patent Application Publication
(10) Pub. No.: US 2014/0048306 A1
(43) Pub. Date: Feb. 20, 2014

(54) Apparatus for Patterning Ribbon, String Tabbing Method and Solar Cell Module Using the Same

(71) Applicant: AU Optronics Corporation, HSIN-CHU (TW)

(72) Inventors: Chun-Ming YANG, HSIN-CHU (TW); Chiuan-Ting LI, HSIN-CHU (TW); Wei-Sheng SU, HSIN-CHU (TW); Kuan-Wen TUNG, HSIN-CHU (TW); Chun-Han TAI, HSIN-CHU (TW); Yi-Chia CHEN, HSIN-CHU (TW); Jen-Guey JIANG, HSIN-CHU (TW)

(73) Assignee: AU Optronics Corporation, HSIN-CHU (TW)

(21) Appl. No.: 13/949,359

(22) Filed: Jul. 24, 2013

(30) Foreign Application Priority Data
Aug. 14, 2012 (CN) 201210289006.6

(51) Int. Cl. H01B 5/02; H01B 13/00

(52) U.S. Cl. CPC H01B 5/02; H01B 13/00
USPC 174/133 R; 29/745; 29/825

(57) ABSTRACT

An apparatus for patterning a ribbon includes a holding device, a heating device, and an embossing device. The holding device is utilized for positioning the ribbon on a surface of a solar cell. The first solder layer contacts the solar cell. The heating device is utilized for melting the ribbon for string tabbing on the solar cell. The embossing device is utilized for contacting the melted ribbon to form a pattern on the ribbon. A surface energy between the ribbon and the solar cell is greater than a surface energy between the ribbon and the embossing device.

### RELATED APPLICATIONS

This application claims priority to Chinese Application Serial Number 201210289006.6, filed Aug. 14, 2012, which is herein incorporated by reference.

### BACKGROUND

1. Field of Invention

The present invention relates to a solar cell. More particularly, the present invention relates to a ribbon for a solar cell.

2. Description of Related Art

Solar energy can be used as an energy source. With the ever-increasing shortage of resources, as well as the pollution and safety problems caused by the use of fossil fuel or nuclear energy we face today, solar energy is an alternative energy resource with potential, and in fact, many developed countries and large-scale enterprises are striving to develop this alternative resource. A solar cell module is often used for this purpose,

A solar cell module is typically installed on a roof or similar location to ensure that the solar cell module is directly irradiated by the sunlight and is not easily shielded by shadows. The solar cell module includes the main elements of solar cells, sealants, back sheets, and a frame for fastening the solar cells, the sealants, and the back sheets. In order to improve the output power of the solar cell module, the solar cells are typically connected to each other with ribbons. However, since the ribbons are reflective, the sunlight emitting on the ribbons is reflected, resulting in a power loss of about 2%-3%.

### SUMMARY

The invention provides an apparatus for forming a pattern on the surface of a ribbon, thereby increasing the efficiency of a solar cell.

An aspect of the invention provides an apparatus for patterning a ribbon on a solar cell. The ribbon has a first solder layer and a second solder layer opposite to each other. The apparatus includes a conveyer, a holding device, a heating device, an embossing device, and a controlling device. The solar cell is disposed on the conveyer. The holding device is disposed above the conveyer and is movable upward and downward relative to the conveyer for positioning the ribbon on a surface of the solar cell. The first solder layer contacts the solar cell. The heating device is disposed above the conveyer for melting the first solder layer and the second solder layer in order to perform string tabbing of the ribbon on the solar cell. The embossing device is disposed above the conveyer and is movable upward and downward relative to the conveyer for contacting the melted second solder layer and forming a pattern on the second solder layer. A surface energy between the first solder layer and the solar cell is greater than a surface energy of between the second solder layer and the embossing device. The controlling unit is electrically connected to and controls the conveyer, the holding device, the heating device, and the embossing device.

The heating device can be a contact type heating device, and the embossing device and the heating device are integrated into a thermal pressing unit. The thermal pressing unit is made of a material having large surface energy with the second solder layer. The thermal pressing unit comprises an undulating surface, and an undulation of the pattern of the ribbon is greater than an undulation of the undulating surface. The apparatus may optionally include a flux disposed on the second solder layer.

The heating device can be a non-contact type heating device, and each of the holding device, the heating device, and the embossing device is a separate element. The embossing device is made of a material having low surface energy with the second solder layer. The embossing device comprises an undulating surface, and an undulation of the undulating surface is substantially equal to an undulation of the pattern of the ribbon. A surface of the holding device for contacting the ribbon can be a textured surface.

The heating device can be a non-contact heating device, and the holding device and the embossing device are integrated into a press head unit. The press head unit is made of a material having low surface energy with the second solder layer. The press head unit comprises an undulating surface, and an undulation of the undulating surface is substantially equal to an undulation of the pattern of the ribbon.

A surface of the conveyer contacting the ribbon can include a protrusive texture. The conveyer can include a conveying belt.

An aspect of the invention provides a string tabbing method utilized by the apparatus. The method includes disposing the ribbon on the solar cell, moving the holding device to contact the ribbon, pressing the thermal pressing unit to contact the ribbon for melting and deforming the second solder layer, lifting the thermal pressing unit for guiding deformation of the second solder layer, in which the second solder layer is solidified from bottom to top to form the pattern in a manner having an undulation, and removing the holding device. A shape of the pattern of the second solder layer is determined according to a lifting speed and a lifting height of the thermal pressing unit.

An aspect of the invention provides a string tabbing method utilized by the apparatus. The method comprises disposing the ribbon on the solar cell, moving the holding device to contact the ribbon, heating the ribbon by the heating device for melting the second solder layer, pressing the embossing device to contact the ribbon, removing the heating device for solidifying the second solder layer, and removing the embossing device and the holding device.

An aspect of the invention provides a string tabbing method utilized by the apparatus. The method comprises disposing the ribbon on the solar cell, moving the pressing head unit to contact the ribbon, heating the ribbon by the heating device for melting and deforming the second solder layer, removing the heating device for solidifying the second solder layer, and removing the pressing head unit.

An aspect of the invention provides a solar cell module, which comprises a plurality of solar cells, and at least one ribbon for connecting the solar cells. The ribbon comprises a patterned surface, the patterned surface comprises at least one first pattern section and at least one second pattern section, an area of the second pattern section is smaller than an area of the first pattern section, and there is a gap between the first pattern section and the second pattern section. The first pattern section and the second pattern section are not continuous.

In the apparatus for patterning a ribbon of the invention, an undulating pattern is formed on the ribbon, so that light emitting on the ribbon can be reflected and scattered toward the solar cell and be utilized by the solar cell, thereby increasing the output power of the solar cell. The step for patterning the ribbon can be performed simultaneously with or after the string tabbing process, such that the problem of deformation of a pre-formed ribbon pattern during the string tabbing process in the prior art can be prevented. The apparatus for patterning the ribbon can be integrated with a stringer without the need for an additional positioning system.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram of a first embodiment of an apparatus for patterning a ribbon of the invention;

FIG. 2A to FIG. 2F are schematic diagrams for describing different steps of a string tabbing method utilized by the apparatus for patterning a ribbon of FIG. 1;

FIG. 3 is a schematic diagram of a second embodiment of the apparatus for patterning a ribbon of the invention;

FIG. 4A to FIG. 4E are schematic diagrams for describing different steps of a string tabbing method utilized by the apparatus for patterning a ribbon of FIG. 3;

FIG. 5 is a schematic diagram of a third embodiment of the apparatus for patterning a ribbon of the invention;

FIG. 6A to FIG. 6F are partial sectional views taken along line A-A of FIG. 5 for describing different steps of a string tabbing method utilized by the apparatus for patterning a ribbon of FIG. 5; and

FIG. 7 is a schematic diagram of an embodiment of a solar cell module of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

The present invention provides an apparatus for patterning a ribbon, in which the apparatus forms an undulating surface on the ribbon. Light emitting on the surface of the ribbon can be scattered and reflected back to the surface of a solar cell to thereby be utilized by the solar cell. The apparatus for patterning a ribbon can be integrated in a string tabbing process. The string tabbing process is one of a number of processes in solar cell module fabrication associated with typically the highest heating temperature. Therefore, by integrating the process of patterning a ribbon in the string tabbing process, the problem of melting of an undulating surface of a pre-patterned ribbon so that the undulating surface becomes flat can be prevented.

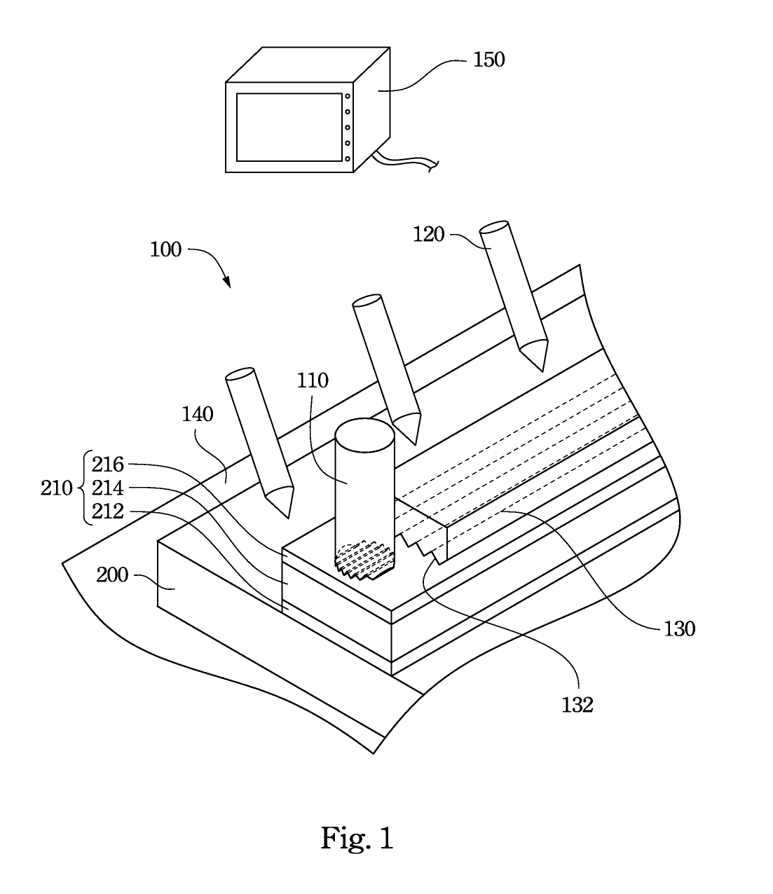

FIG. 1 is a schematic diagram of a first embodiment of an apparatus for patterning a ribbon of the invention. The apparatus 100 is utilized for patterning a ribbon 210. The ribbon 210 includes a first solder layer 212, a copper layer 214, and a second solder layer 216. The first solder layer 212 and the second solder layer 216 are disposed at opposite surfaces of the copper layer 214, respectively. The apparatus 100 includes a holding device 110, a heating device 120, an embossing device 130, a conveying belt 140, and a controlling unit 150. Each of the holding device 110, the heating device 120, and the embossing device 130 is a separate device. The controlling unit 150 is electrically connected to the conveying belt 140, the holding device 110, the heating device 120, and the embossing device 130 for controlling the conveying belt 140, the holding device 110, the heating device 120, and the embossing device 130.

The solar cell 200 and the ribbon 210 are disposed on the conveying belt 140. The holding device 110 is disposed above the conveying belt 140 and is movable upward and downward relative to the conveying belt 140 for positioning the ribbon 210 on a surface of the solar cell 200. The first solder layer 212 contacts the solar cell 200 when the ribbon 210 is placed on the solar cell 200. A surface of the holding device 110 can be a flat surface or a textured surface. In this embodiment, the surface of the holding device 110 contacting the ribbon 210 is a textured surface. The heating device 120 is disposed above the conveying belt 140. The heating device 120 can be a non-contact type heating device, such as a thermal flow heater or an infrared heater, for heating the ribbon 210 in a contactless manner. The first solder layer 212 and the second solder layer 216 are melted when the ribbon 210 is heated. The melted first solder layer 212 is in contact with a top surface of the solar cell 200. The top surface of the solar cell 200 can be a silver paste layer. There is a significant surface energy (or active energy) between the silver paste layer and the first solder layer 212, so that the ribbon 210 is soldered on the solar cell 200.

The embossing device 130 is disposed above the conveying belt 140, and the embossing device 130 is movable upward and downward relative to the conveying belt 140. The embossing device 130 has an undulating surface 132 for contacting the melted second solder layer 216 and forming a pattern on the second solder layer 216. The pattern of the undulating surface 132 can be a regular or an irregular pattern. The surface energy between the first solder layer 212 and the solar cell 200 must be larger than the surface energy between the second solder layer 216 and the embossing device 130, such that the ribbon 210 can be combined with the solar cell 200. For example, the material of the embossing device 130 can be a surface-treated high temperature resistant metal or polymer, such as Teflon®, in order to prevent the solidified solder from binding with the embossing device 130. Furthermore, a flux can be optionally spread on the surface of the solar cell 200 for increasing the active energy between the solar cell 200 and the ribbon 210. The conveying belt 140 is utilized as a conveyer in this embodiment. However, the conveying belt 140 can be replaced by any suitable conveyer, such as conveying rollers in other embodiments.

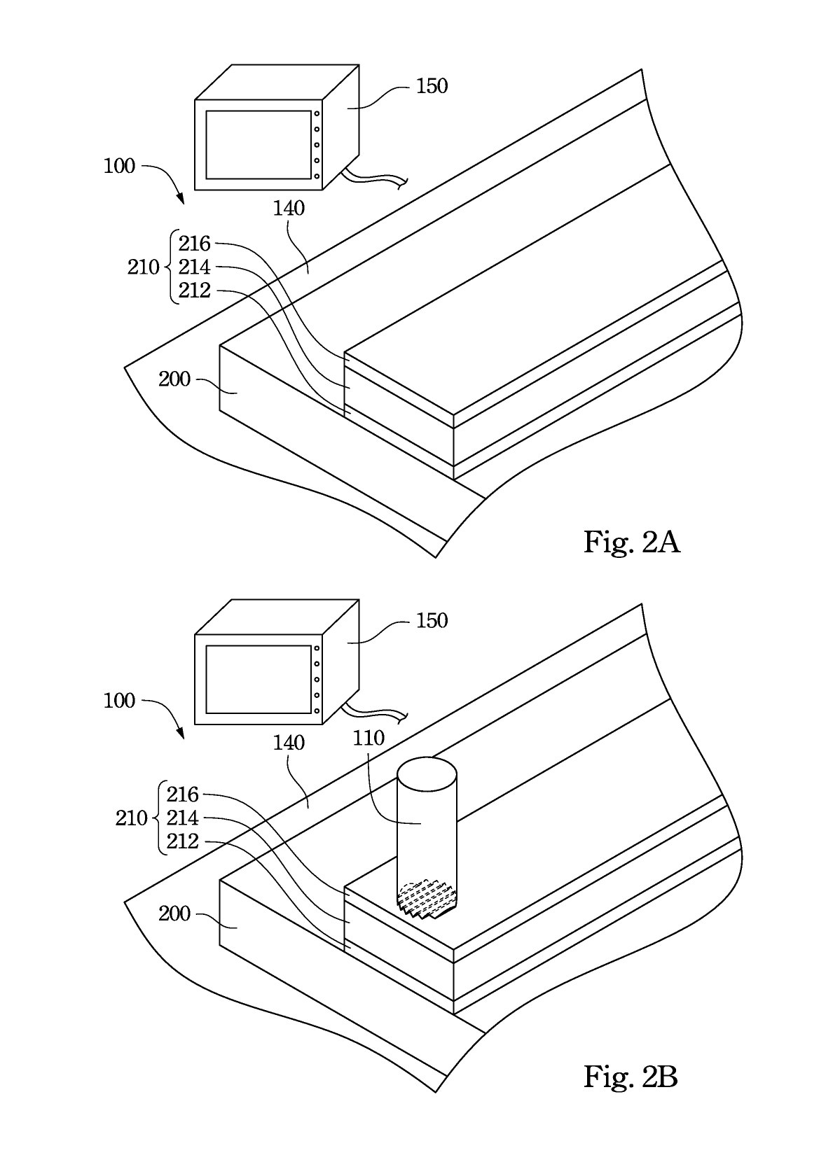

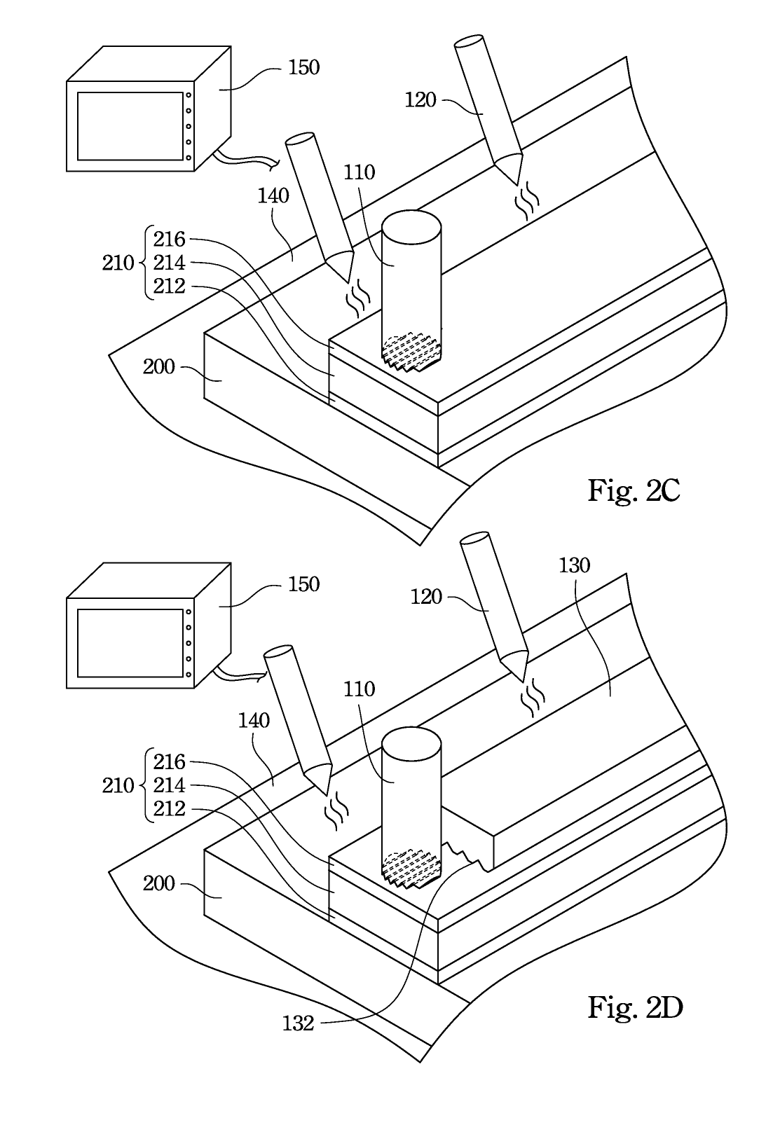

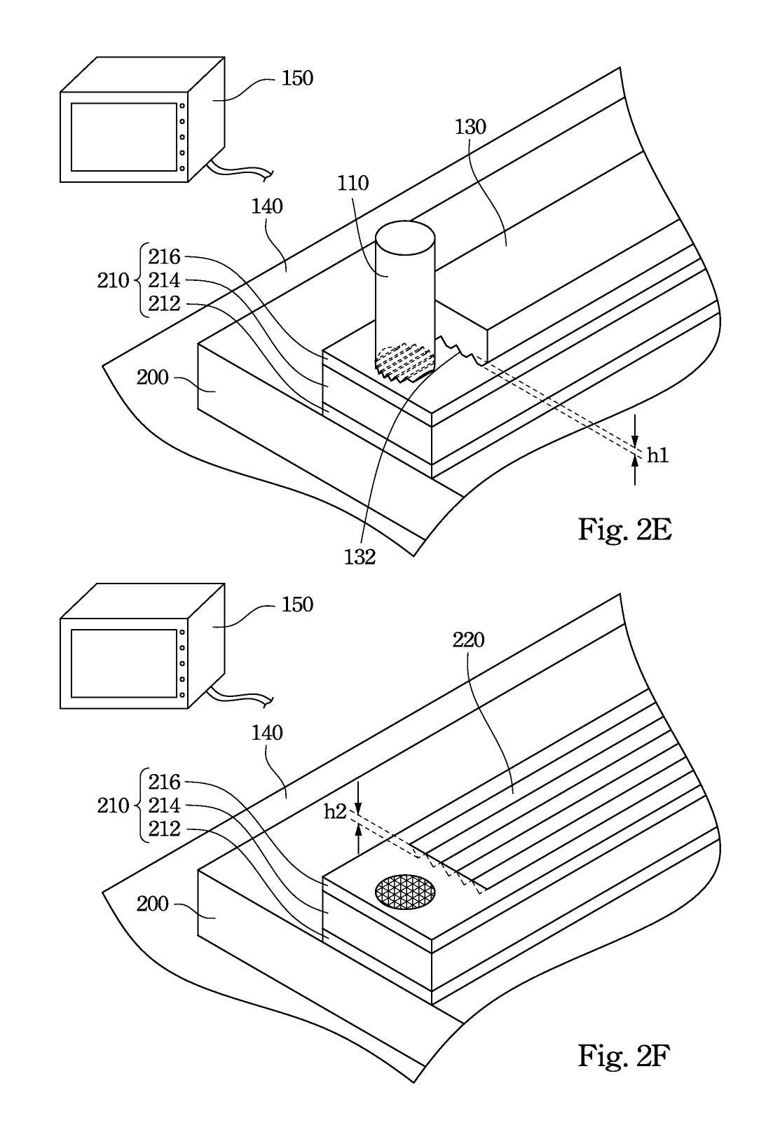

FIG. 2A to FIG. 2F are schematic diagrams for describing different steps of a string tabbing method utilized by the apparatus 100 of FIG. 1.

In FIG. 2A, the conveying belt 140 with the solar cell 200 disposed thereon is moved to a predetermined position. The ribbon 210 is disposed on the solar cell 200 in such a manner that the first solder layer 212 thereof contacts the surface of the solar cell 200. The surface of the ribbon 210 is flat when the ribbon 210 is disposed on the solar cell 200, so that the ribbon 210 can be moved utilizing an existing stringer without problems occurring due to vacuum absorption.

In FIG. 2B, the holding device 110 is moved to contact the ribbon 210, such that the ribbon 210 is positioned securely on the solar cell 200.

In FIG. 2C, the ribbon 210 is heated by the heating device 120, so that the first solder layer 212 and the second solder layer 216 are melted. The heating device 120 can be a non-contact type heating device, such as a thermal flow heater or an infrared heater.

In FIG. 2D, the embossing device 130 is pressed to contact the ribbon 210. A pattern corresponding to the pattern of the undulating surface 132 of the embossing device 130 is formed on the melted second solder layer 216. When the surface contacting the ribbon 210 of the holding device 110 is a textured surface, another pattern corresponding to the textured surface would be also formed on the melted second solder layer 216.

In FIG. 2E, the heating device 120 is removed, such that the first solder layer 212 and the second solder layer 216 are cooled and solidified to thereby fix the pattern on the second solder layer 216.

In FIG. 2F, the embossing device 130 and the holding device 110 are removed. The embossing device 130 has the undulating surface 132, as described above. With additional reference to FIG. 2E, an undulation h1 of the undulating surface 132 is substantially equal an undulation h2 of the pattern 220 of the ribbon 210. Namely, the pattern 220 of the ribbon 210 corresponds to the undulating surface 132 of the embossing device 130.

More particularly, the embossing device 130 is removed from the ribbon 210 after the heating device 120 is removed and the pattern 220 is fixed on the ribbon 210, so that the pattern 220 is made permanent on the surface of the ribbon 220 after the embossing device 130 is removed from the ribbon 210. The embossing device 130 is preferably made of a high temperature resistant metal or a polymer having low surface energy with the second solder layer 216.

If a back surface of the solar cell 200 can also be utilized for collecting light, the apparatus and the method disclosed above can be applied also to a ribbon at the back surface of the solar cell 200 (not shown). For example, the surface of the conveying belt 140 may be a textured surface having a protrusive texture, and a corresponding pattern may be formed on the surface of the ribbon disposed at the back surface of the solar cell 200 when this ribbon is melted and in contact with the conveying belt 140.

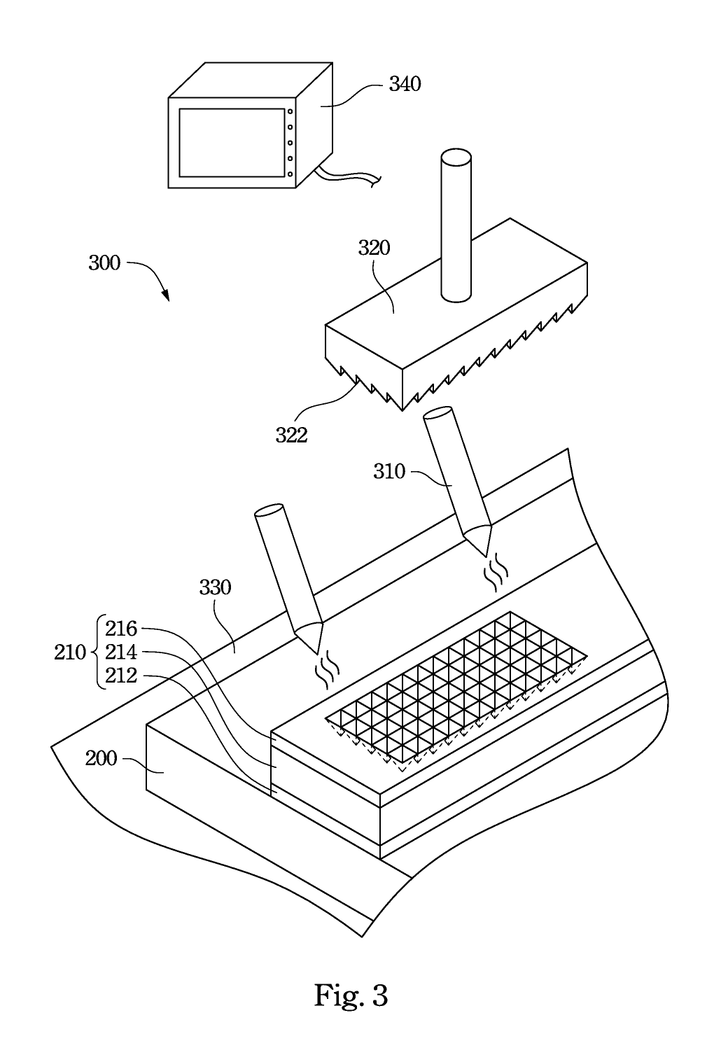

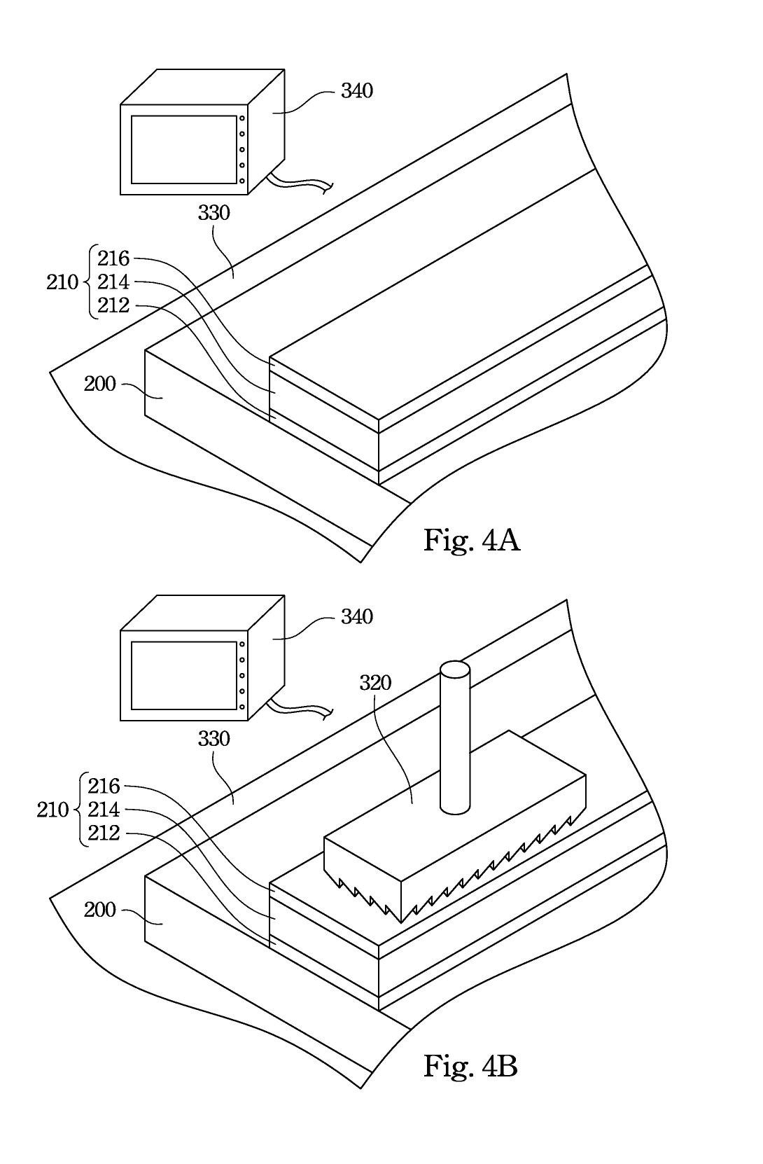

FIG. 3 is a schematic diagram of a second embodiment of the apparatus for patterning a ribbon of the invention. The apparatus 300 is utilized for forming a pattern on a surface of the ribbon 210 when the ribbon 210 is serial soldered on the solar cell. The apparatus ribbon 300 includes a heating device 310, a press head unit 320, a conveying belt 330, and a controlling unit 340. The heating device 310 is a non-contact heating device, such as a thermal flow heater or an infrared heater. The press head unit 320 is an integrated element of a holding device and an embossing device. The press head unit 320 includes an undulating surface 322. The surface of the conveying belt 330 can be a flat surface or a textured surface. The controlling unit 340 is electrically connected to the heating device 310, the press head unit 320, and the conveying belt 330 for controlling the heating device 310, the press head unit 320, and the conveying belt 330.

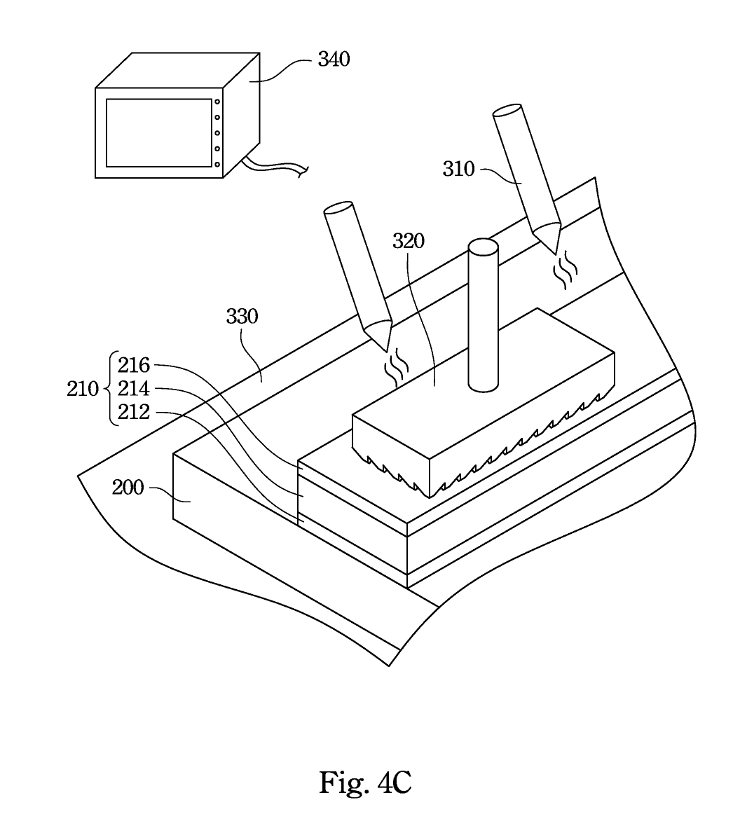

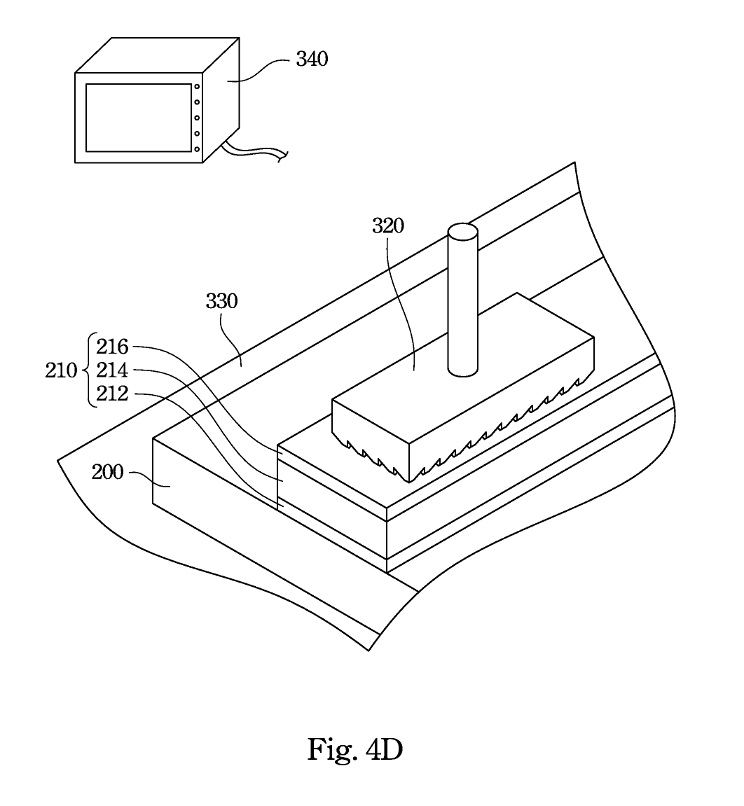

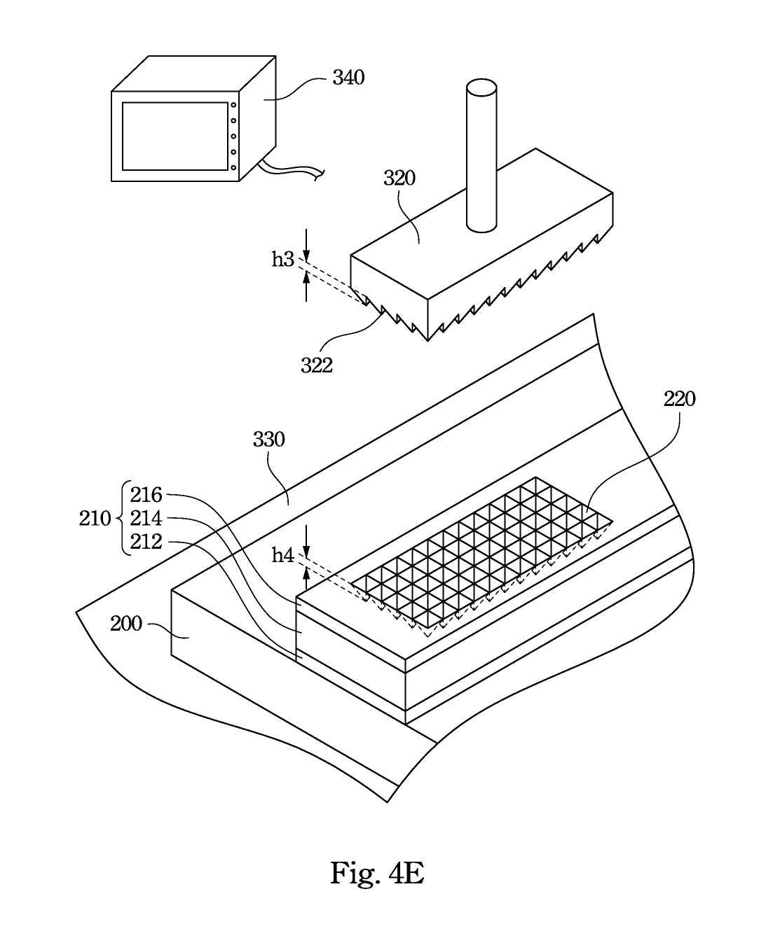

FIG. 4A to FIG. 4E are schematic diagrams for describing different steps of a string tabbing method utilized by the apparatus 300 of FIG. 3.

In FIG. 4A, the conveying belt 330 with the solar cell 200 disposed thereon is moved to a predetermined position. The ribbon 210 is disposed on the solar cell 200 in such a manner that the first solder layer 212 thereof contacts the surface of the solar cell 200. The surface of the ribbon 210 is flat when the ribbon 210 is disposed on the solar cell 200, so that the ribbon 210 can be moved utilizing an existing stringer without problems occurring due to vacuum absorption.

In FIG. 4B, the press head unit 320 is moved to contact the ribbon 210, such that the ribbon 210 is positioned securely on the solar cell 200.

In FIG. 4C, the ribbon 210 is heated by the heating device 310, so that the first solder layer 212 and the second solder layer 216 are melted. The heating device 310 can be a non-contact type heating device, such as a thermal flow heater or an infrared heater. The press head unit 320 may contact the melted second solder layer 216, so that the second solder layer 216 is deformed corresponding to the undulating surface 322, and a pattern corresponding to the pattern of the undulating surface 322 of the press head unit 320 is formed on the melted second solder layer 216. In FIG. 4D, the heating device 310 is removed, such that the first solder layer 212 and the second solder layer 216 are cooled and solidified to thereby fix the pattern on the second solder layer 216.

In FIG. 4E, the press head unit 320 is removed. The press head unit 320 has the undulating surface 322, as described above. An undulation h3 of the undulating surface 322 is substantially equal an undulation h4 of the pattern 220 of the ribbon 210. Namely, the pattern 220 of the ribbon 210 corresponds to the undulating surface 322 of the press head unit 320.

More particularly, the press head unit 320 is removed from the ribbon 210 after the heating device 310 is removed and the pattern 220 is fixed on the ribbon 210, so that the pattern 220 is made permanent on the surface of the ribbon 220 after the press head unit 320 is removed from the ribbon 210. The press head unit 320 is preferably made of a high temperature resistant metal or a polymer having low surface energy with the second solder layer 216, such as Teflon®, in order to prevent the solidified solder from binding with the press head unit 320.

If a back surface of the solar cell 200 can also be utilized for collecting light, the apparatus and the method disclosed above can be applied also to a ribbon at the back surface of the solar cell 200 (not shown). For example, the conveying belt 330 may have a textured surface, and a corresponding pattern may be formed on the surface of the ribbon 210 disposed at the back surface of the solar cell 200 when this ribbon is melted and in contact with the conveying belt 330.

Unlike when only using the holding device for positioning, the press head unit 320 in this embodiment can provide a larger contact area between the press head unit 320 and the ribbon 210. As a result, the stress between the press head unit 320 and the ribbon 210 can be spread, and a situation in which the solar cell is damaged during positioning of the ribbon 210 can be prevented.

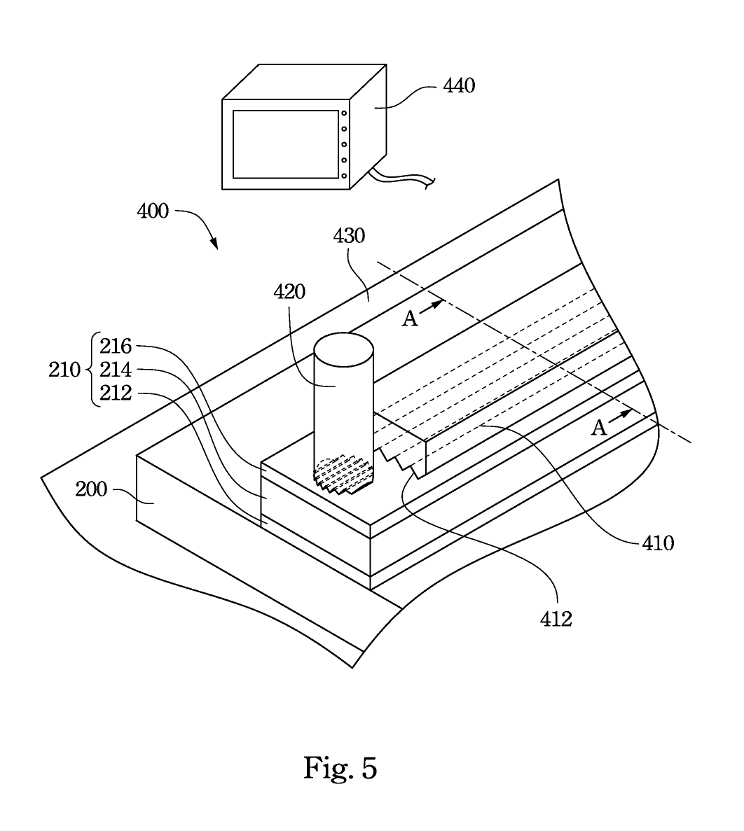

FIG. 5 is a schematic diagram of a third embodiment of the apparatus for patterning a ribbon of the invention. The apparatus 400 includes a thermal pressing unit 410, a holding device 420, a conveying belt 430, and a controlling unit 440. The thermal pressing unit 410 is an integrated element including an embossing device and a heating device. The thermal pressing unit 410 contacts the ribbon 210 for heating the ribbon 210. The thermal pressing unit 410 includes an undulating surface 412. The surface of the conveying belt 430 can be a flat surface or a textured surface. The controlling unit 440 is electrically connected to the thermal pressing unit 410, the holding device 420, and the conveying belt 430 for controlling the thermal pressing unit 410, the holding device 420, and the conveying belt 430.

The thermal pressing unit 410 contacts the ribbon 210 and simultaneously heats the ribbon 210. The second solder layer 216 is deformed when the ribbon 210 is heated. The second solder layer 216 is cooled and solidified for fixing the pattern thereon when the thermal pressing unit 410 is removed from the ribbon 210. Therefore, the thermal pressing unit 410 is preferably made of a material having high surface energy with the ribbon 210, such as metal utilized on a soldering bit, copper, iron, ceramic, surface-treated metal, or high temperature oxidation resistance metal. As a result, the solder of the second solder layer 216 can be guided upward due to the surface energy between the second solder layer 216 and the thermal pressing unit 410.

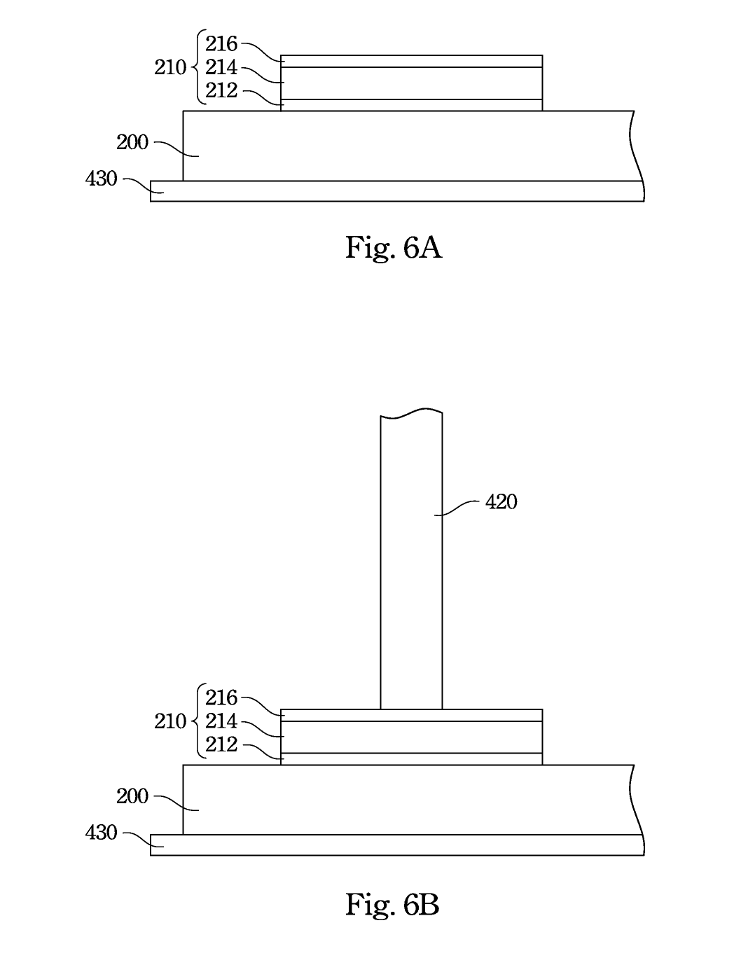

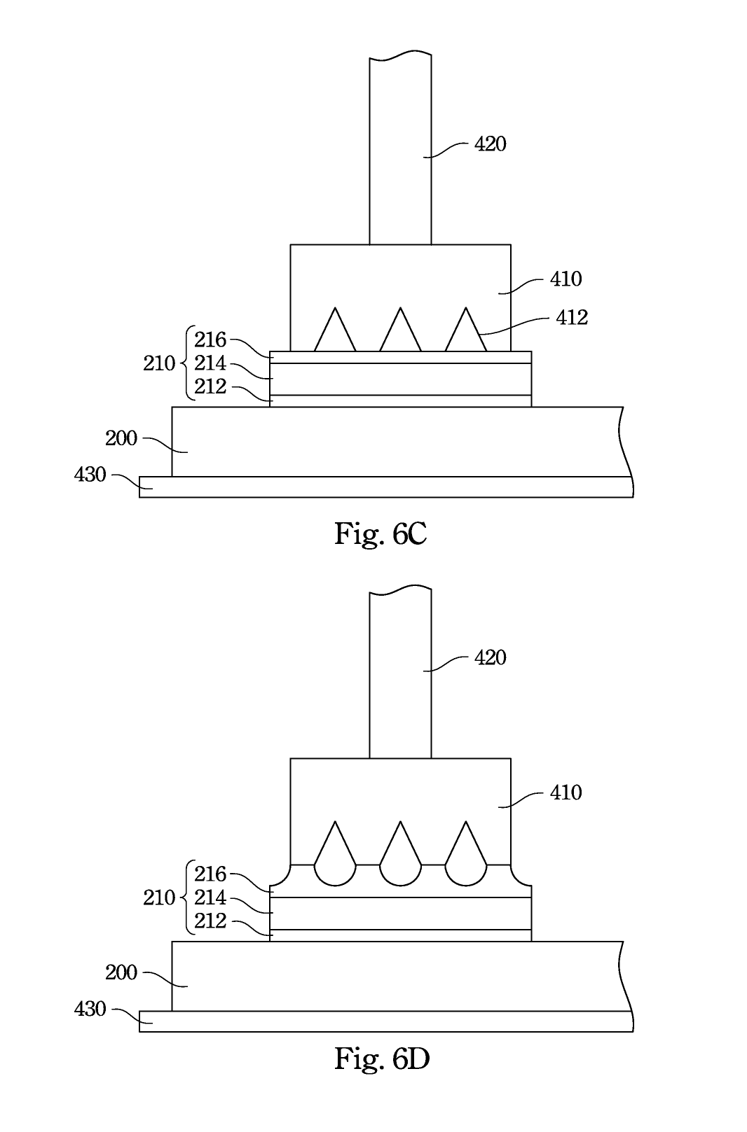

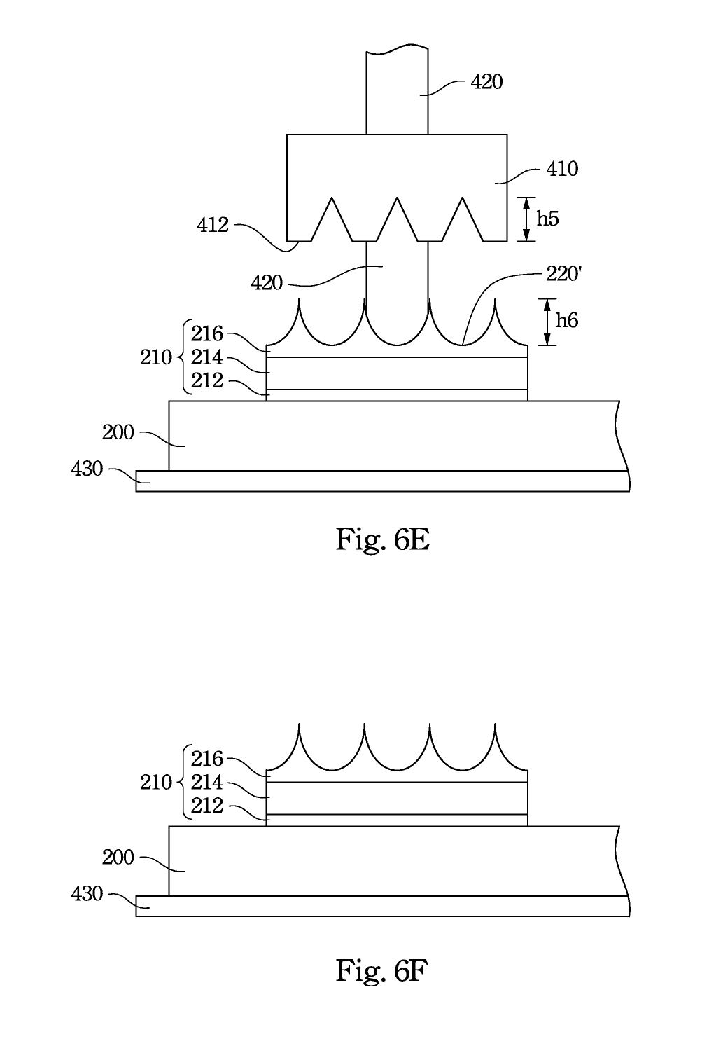

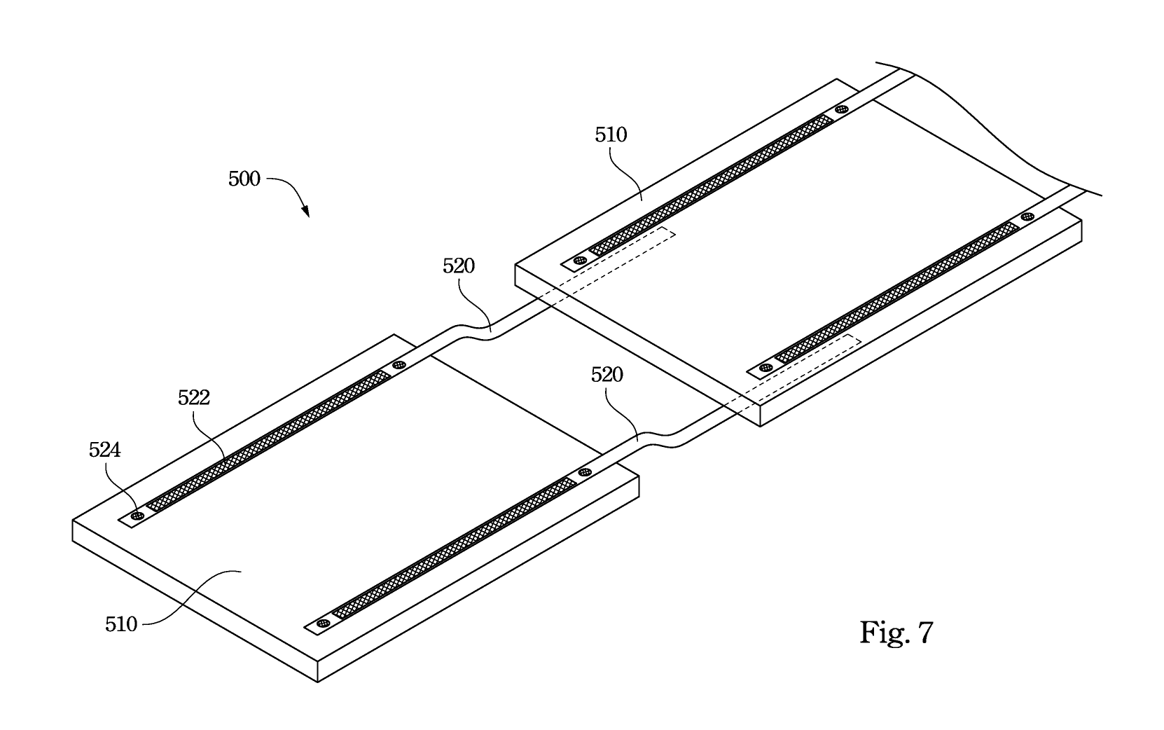

FIG. 6A to FIG. 6F are partial sectional views taken along line A-A of FIG. 5 for describing different steps of a string tabbing method utilized by the apparatus 400 of FIG. 5.

In FIG. 6A, the conveying belt 430 with the solar cell 200 disposed thereon is moved to a predetermined position. The ribbon 210 is disposed on the solar cell 200 in such a manner that the first solder layer 212 thereof contacts the surface of the solar cell 200. The surface of the ribbon 210 is flat when the ribbon 210 is disposed on the solar cell 200, so that the ribbon 210 can be moved utilizing an existing stringer without problems occurring due to vacuum absorption.

In FIG. 6B, the holding device 420 is moved to contact the ribbon 210, such that the ribbon 210 is positioned securely on the solar cell 200.

In FIG. 6C, the thermal pressing unit 410 is moved to contact and heat the ribbon 210, so that the first solder layer 212 and the second solder layer 216 of the ribbon 210 are melted. The thermal pressing unit 410 contacts the melted second solder layer 216. The pressing distance of the thermal pressing unit 410 can be designed to prevent too much solder of the melted second solder layer 216 from entering the spaces in the undulating surface 412.

In FIG. 6D, the thermal pressing unit 410 is lifted. The thermal pressing unit 410 is made of a material having high surface energy with the second solder layer 216 of the ribbon 210. Therefore, the second solder layer 216 is guided and raised by the thermal pressing unit 410, thereby forming an undulating pattern on the second solder layer 216.

In FIG. 6E, the thermal pressing unit 410 is removed from the ribbon 210, and the first solder layer 212 and the second solder layer 216 are cooled and solidified from bottom to top when the thermal pressing unit 410 is lifted, thereby fixing the pattern 220′ on the second solder layer 216. A shape of the pattern 220′ is determined according to a lifting speed and a lifting height of the thermal pressing unit 410. Namely, the shape of the pattern 220′ on the ribbon 210 can be varied by adjusting the lifting speed and lifting height of the thermal pressing unit 410. The pattern 220′ is fixed when the thermal pressing unit 410 is lifted, so that an undulation h6 of the pattern 220′ of the ribbon 210 is greater than an undulation h5 of the undulating surface 412 of the thermal pressing unit 410. Namely, the pattern 220′ of the ribbon 210 does not correspond to the undulating surface 412 of the thermal pressing unit 410.

In FIG. 6F, the holding device 420 is removed.

FIG. 7 is a schematic diagram of an embodiment of a solar cell module of the invention. The solar cell module 500 includes plural solar cells 510, and at least one ribbon 520 for connecting the solar cells 510. The ribbon 520 includes a patterned surface. The patterned surface includes at least one first pattern section 522 and at least one second pattern section 524. The first pattern section 522 can be formed by the embossing device 130, the press head unit 320, or the thermal pressing unit 410 as disclosed previously. The second pattern section 524 can be formed by the holding device 110, 420. The area of the second pattern section 524 is smaller than the area of the first pattern section 522. The pattern of the first pattern section 522 can be the same as or different from the pattern of the second pattern section 524. There is a gap between the first pattern section 522 and the second pattern section 524. That is, the first pattern section 522 and the second pattern section 524 are not continuous. The first pattern section 522 and the second pattern section 524 can be formed by the apparatus for patterning a ribbon or can be realized by a textured surface of a conveying belt. A ribbon arranged at the back surface of the solar cell 510 (not shown) can also be formed with a first pattern section and a second pattern section.

The apparatus for patterning a ribbon of the invention can form an undulating pattern on the ribbon, so that light emitting onto the ribbon can be reflected and scattered toward the solar cell and be utilized by the solar cell, thereby increasing the output power of the solar cell. The step for patterning the ribbon can be performed simultaneously with or after the string tabbing process, such that the problem of deformation of a pre-formed ribbon pattern during the string tabbing process in the prior art can be prevented. The apparatus for patterning a ribbon can be integrated with a stringer without the need for an additional positioning system.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for patterning a ribbon on a solar cell, the ribbon having a first solder layer and a second solder layer opposite to each other, the apparatus comprising:
a conveyer, the solar cell being disposed on the conveyer;
a holding device disposed above the conveyer and being movable upward and downward relative to the conveyer for positioning the ribbon on a surface of the solar cell, wherein the first solder layer contacts the solar cell;
a heating device disposed above the conveyer for melting the first solder layer and the second solder layer in order to perform string tabbing of the ribbon on the solar cell;
an embossing device disposed above the conveyer and being movable upward and downward relative to the conveyer for contacting the melted second solder layer and forming a pattern on the second solder layer, wherein a surface energy between the first solder layer and the solar cell is greater than a surface energy of between the second solder layer and the embossing device; and
a controlling unit electrically connected to and controlling the conveyer, the holding device, the heating device, and the embossing device.

2. The apparatus of claim 1, wherein the heating device is a contact type heating device, and the embossing device and the heating device are integrated into a thermal pressing unit.

3. The apparatus of claim 2, wherein the thermal pressing unit is made of a material having large surface energy with the second solder layer.

4. The apparatus of claim 2, wherein the thermal pressing unit comprises an undulating surface, and an undulation of the pattern of the ribbon is greater than an undulation of the undulating surface.

5. The apparatus of claim 2, further comprising a flux disposed on the second solder layer.

6. The apparatus of claim 1, wherein the heating device is a non-contact type heating device, and each of the holding device, the heating device, and the embossing device is a separate element.

7. The apparatus of claim 6, wherein the embossing device is made of a material having low surface energy with the second solder layer.

8. The apparatus of claim 6, wherein the embossing device comprises an undulating surface, and an undulation of the undulating surface is substantially equal to an undulation of the pattern of the ribbon.

9. The apparatus of claim 6, wherein a surface of the holding device for contacting the ribbon is a textured surface.

10. The apparatus of claim 1, wherein the heating device is a non-contact heating device, and the holding device and the embossing device are integrated into a press head unit.

11. The apparatus of claim 10, wherein the press head unit is made of a material having low surface energy with the second solder layer.

12. The apparatus of claim 10, wherein the press head unit comprises an undulating surface, and an undulation of the undulating surface is substantially equal to an undulation of the pattern of the ribbon.

13. The apparatus of claim 1, wherein a surface of the conveyer contacting the ribbon comprises a protrusive texture.

14. The apparatus of claim 1, wherein the conveyer comprises a conveying belt.

15. A string tabbing method utilized by the apparatus of claim 2, the method sequentially comprising:
disposing the ribbon on the solar cell;
moving the holding device to contact the ribbon;
pressing the thermal pressing unit to contact the ribbon for melting and deforming the second solder layer;
lifting the thermal pressing unit for guiding deformation of the second solder layer, wherein the second solder layer is solidified from bottom to top to form the pattern in a manner having an undulation; and
removing the holding device.

16. The string tabbing method of claim 15, wherein a shape of the pattern of the second solder layer is determined according to a lifting speed and a lifting height of the thermal pressing unit.

17. A string tabbing method utilized by the apparatus of claim 6, the method sequentially comprising:
disposing the ribbon on the solar cell;
moving the holding device to contact the ribbon;
heating the ribbon by the heating device for melting the second solder layer;
pressing the embossing device to contact the ribbon;
removing the heating device for solidifying the second solder layer; and
removing the embossing device and the holding device.

18. A string tabbing method utilized by the apparatus of claim 10, the method sequentially comprising:
disposing the ribbon on the solar cell;
moving the pressing head unit to contact the ribbon;
heating the ribbon by the heating device for melting and deforming the second solder layer;
removing the heating device for solidifying the second solder layer; and
removing the pressing head unit.

19. A solar cell module comprising:
a plurality of solar cells; and
at least one ribbon for connecting the solar cells, wherein the ribbon comprises a patterned surface, the patterned surface comprises at least one first pattern section and at least one second pattern section, an area of the second pattern section is smaller than an area of the first pattern section, and there is a gap between the first pattern section and the second pattern section.

20. The solar cell module of claim 19, wherein the first pattern section and the second pattern section are not continuous.
